(19) United States
(12) Patent Application Publication
(10) Pub. No.: US 2011/0304270 A1
(43) Pub. Date: Dec. 15, 2011

(54) LIGHT EMITTING DIODE (LED) LIGHTING SYSTEMS AND METHODS

(75) Inventor: Richard Scarpelli, Oceanside, CA (US)

(73) Assignee: ECO LUMENS, LLC, Oceanside, CA (US)

(21) Appl. No.: 13/158,314

(22) Filed: Jun. 10, 2011

Related U.S. Application Data
(60) Provisional application No. 61/353,643, filed on Jun. 10, 2010.

(51) Int. Cl. H01J 13/32

(52) U.S. Cl. 315/113

(57) ABSTRACT

Methods, systems, and devices for light emitting diode (LED) lighting, including at least one of a multi-channel LED driver circuit including an electromagnetic interference (EMI) filter and rectification circuit, a power factor correction (PFC) circuit, a current and voltage isolation circuit, a voltage control circuit, and a current control circuit; a printed circuit board (PCB) including one or more surface mount or screw mount LEDs and electrically coupled to the LED driver circuit; a heat sink including an intercooling and ventilation chamber for air or water cooling disposed therein and thermally coupled to the PCB; and a lens housing having one or more lenses integrally formed therein and removably coupled to the heat sink with the lenses disposed over the LEDs.

### CROSS REFERENCE TO RELATED DOCUMENTS

The present invention claims benefit of priority to U.S. Provisional Patent Application Ser. No. 61/353,643 of Richard SCARPELLI, entitled “LIGHT EMITTING DIODE (LED) LIGHTING SYSTEMS AND METHODS,” filed on Jun. 10, 2010, the entire disclosure of which is hereby incorporated by reference herein.

### BACKGROUND OF THE INVENTION

1. Field of the Invention

The present invention generally relates to systems and methods for providing lighting, and more particularly to improved light emitting diode (LED) lighting systems and methods.

2. Discussion of the Background

In recent years, 22% of all electrical energy is used for lighting. Of this electrical lighting energy, 42% is generated by incandescent bulbs, which represents about 9% of total electricity used. Accordingly, there is a need to develop systems and methods that provide better lighting, with greater efficiency, less heat and more brightness than conventional lighting, while at the same lowering the overall cost of electrical lighting use.

In addition, traditional lighting, for example, using incandescent and fluorescent lamps, produces a high volume of waste material. By 2017, it is expected that incandescent light bulb will be totally eliminated due to energy standards for energy conservation, and which could save up to $18 billion a year in usable electricity. Accordingly, such changes require new standards and the use of all available technology in next generation lighting systems.

Light emitting diodes (LEDs) have been around since about 1965. LED technology is opening doors for further technology progression in lighting systems. In addition, high power LEDs have been developed, but they are often more expensive than fluorescent, and high intensity discharge (HID) light sources. To justify such extra cost, LED lighting systems should produce more light from less electrical power, and should have a longer operating life.

All of the above indicates that there is a need for LED lighting systems and methods that are reliable, cost effective, and that provide improved performance, as compared to conventional lighting systems.

### SUMMARY OF THE INVENTION

Therefore, there is a need improved methods and systems for light emitting diode (LED) lighting that address the above and other problems with conventional lighting systems and methods. The above and other needs are addressed by the exemplary embodiments of the present invention, which provide an improved light emitting diode (LED), solid-state lighting (SSL) systems and methods. The systems and methods can include, for example, improved phase correction circuits, LED driver circuits, printed circuit boards (PCBs), heatsinks, LEDs, lens housings, endcaps, tombstones, adapter plates, brackets, fixtures, retrofit applications, lighting applications, and the like. Advantageously, the novel LED systems and methods can provide average energy savings in the 40% to 80% range, as compared to conventional lighting systems and methods. The novel systems and methods can include interchangeable LED subsystem components that provide high energy, high efficiency, high lumens, and lower heat dissipation, and that can be used in retrofit, as well as new lighting applications, as compared to conventional lighting systems and methods.

Accordingly, in exemplary aspects of the present invention, there are provided methods, systems, and devices for light emitting diode (LED) lighting, including at least one of a multi-channel LED driver circuit including an electromagnetic interference (EMI) filter and rectification circuit, a power factor correction (PFC) circuit, a current and voltage isolation circuit, a voltage control circuit, and a current control circuit; a printed circuit board (PCB) including one or more surface mount or screw mount LEDs and electrically coupled to the LED driver circuit; a heat sink including an intercooling and ventilation chamber for air or water cooling disposed therein and thermally coupled to the PCB; and a lens housing having one or more lenses integrally formed therein and removably coupled to the heat sink with the lenses disposed over the LEDs.

The methods, systems, and devices can include a phase correction circuit coupled to an input of the LED driver circuit.

The methods, systems, and devices can include at least one of endcaps removably connected to ends of the heat sink and lens housing; and tombstones removably connected to the endcaps.

The PCB can be square-shaped with a plurality of the LEDs uniformly dispersed on the PCB and optically aligned with a respective plurality of the lenses.

The PCB can be rectangular-shaped with a plurality of the LEDs uniformly dispersed, in series along a length of the PCB and optically aligned with a single respective lens disposed along a length of the lens housing.

Still other aspects, features, and advantages of the present invention are readily apparent from the following detailed description, simply by illustrating a number of exemplary embodiments and implementations, including the best mode contemplated for carrying out the present invention. The present invention also is capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings, in which like reference numerals refer to similar elements, and in which:

FIGS. 1A-1C are used to illustrate exemplary light emitting diode (LED) lighting systems and methods, according to exemplary embodiments;

FIGS. 2A-2B illustrate exemplary printed circuit boards (PCBs) that can be used in the LED lighting systems and methods of FIGS. 1A-1C, according to exemplary embodiments;

FIGS. 3A-3B illustrate exemplary LED lens housings that can be used in the LED lighting systems and methods of FIGS. 1A-1C, according to exemplary embodiments;

FIGS. 4A-4B illustrate exemplary heatsinks that can be used in the LED lighting systems and methods of FIGS. 1A-1C, according to exemplary embodiments;

FIG. 5 illustrates an exemplary endcap that can be used in the LED lighting system and method of FIG. 1A, according to an exemplary embodiment;

FIG. 6 illustrates an exemplary tombstone that can be used in the LED lighting system and method of FIG. 1A, according to an exemplary embodiment;

FIG. 7 illustrates an exemplary LED driver circuit that can be used in the LED lighting systems and methods of FIGS. 1A-1C, according to an exemplary embodiment;

FIG. 8-9 illustrate exemplary sub-circuits of the LED driver circuit of FIG. 7, according to exemplary embodiments;

FIG. 10 illustrates an exemplary phase correction circuit of the LED lighting systems and methods of FIGS. 1A-1C, according to an exemplary embodiment;

FIG. 11 illustrates an exemplary e-coin LED that can be used in the LED lighting systems and methods of FIGS. 1A-1C, according to an exemplary embodiment;

FIGS. 12-13 illustrate exemplary retrofit applications for the LED lighting systems and methods of FIGS. 1A-1C, according to exemplary embodiments;

FIG. 14A illustrates exemplary adapter plates that can be used with the LED lighting systems and methods of FIGS. 1B-1C, according to exemplary embodiments;

FIG. 14B illustrates exemplary adapter plate applications for the adapter plates of FIG. 14A, according to exemplary embodiments;

FIG. 15 illustrates exemplary brackets that can be used with the LED lighting systems and methods of FIGS. 1B-1C, according to exemplary embodiments;

FIGS. 16A-16B illustrate exemplary light fixtures that can be used with the LED lighting system and method of FIG. 1B, according to exemplary embodiments;

FIGS. 17-20 are exemplary graphs, charts and visuals for illustrating the electrical performance of the LED lighting systems and methods of FIGS. 1A-1C, according to exemplary embodiments;

FIGS. 21-22 are exemplary graphs, charts and visuals for illustrating the electrical performance of LEDs that can be used in the LED lighting systems and methods of FIGS. 1A-1C, according to exemplary embodiments;

FIG. 23 illustrates exemplary lighting applications for the LED lighting systems and methods of FIGS. 1A-1C, according to exemplary embodiments;

FIG. 24 illustrates an exemplary e-coin LED that can be used in the LED lighting systems and methods of FIGS. 1A-1C, according to an exemplary embodiment; and

FIG. 25 illustrates an exemplary sport light fixture that can be used with the e-coin LED of FIG. 24, according to exemplary embodiments.

### DETAILED DESCRIPTION OF THE PREFERRED EMBODIMENTS

Improved methods, systems, and devices for light emitting diode (LED) lighting are described. In the following description, for purposes of explanation, numerous specific details are set forth in order to provide a thorough understanding of the present invention. It is apparent to one skilled in the art, however, that the present invention can be practiced without these specific details or with an equivalent arrangement. In some instances, well-known structures and devices are shown in block diagram form in order to avoid unnecessarily obscuring the present invention.

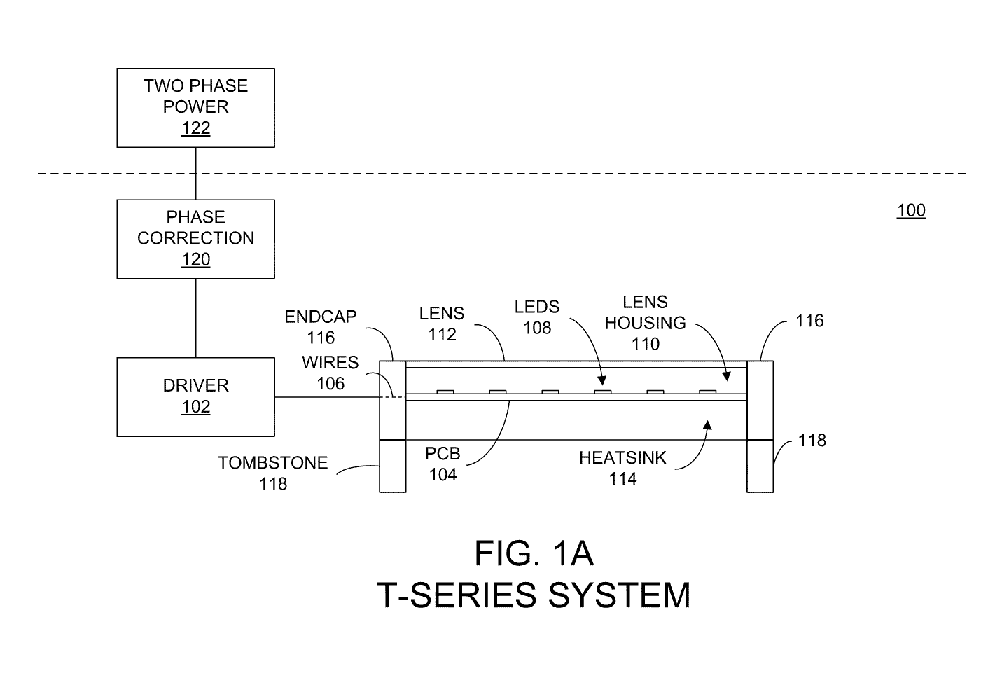

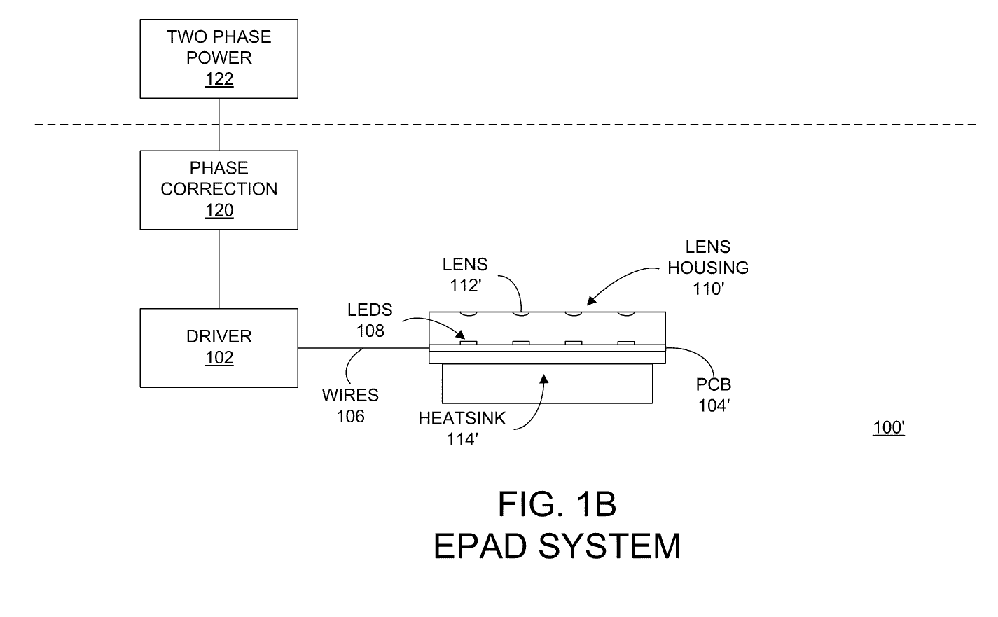

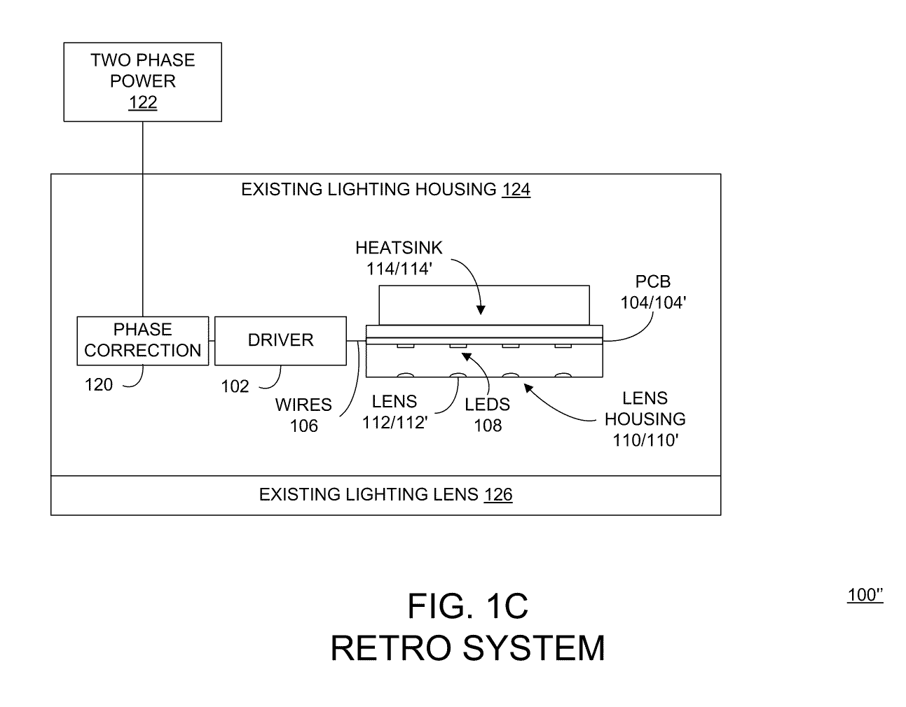

Referring now to the drawings, FIGS. 1A-1C thereof illustrate exemplary light emitting diode (LED) lighting systems and methods, according to exemplary embodiments. In FIG. 1A, an exemplary LED lighting system and method 100 can receive power from a power source 122 (e.g., two-phase, 120 VAC, 240 VAC, etc.), and can include a phase correction circuit 120, an LED driver circuit 102, a printed circuit board (PCB) 104 coupled to the LED driver circuit 102 via wires 106, one or more LEDs 108 (e.g., a Samsung LED package, including 9 individual LED dies in one package), a lens housing 110 having one or more lenses 112, a heatsink 114, endcaps 116, and tombstones 118. Advantageously, the exemplary LED lighting system and method of FIG. 1A can be used with T-series lighting and retrofit applications (e.g., T5, T8 and T10 applications), and the like.

In FIG. 1B, an exemplary LED lighting system and method 100′ can receive power from the power source 122 (e.g., two-phase, 120 VAC, 240 VAC, etc.), and can include the phase correction circuit 120, the LED driver circuit 102, a printed circuit board (PCB) 104′ coupled to the LED driver circuit 102 via the wires 106, the one or more LEDs 108 (e.g., a Samsung LED package, including 9 individual LED dies in one package), a lens housing 110′ having one or more lenses 112′, and a heatsink 114′. Advantageously, the exemplary LED lighting system and method of FIG. 1B can be used with Hubbell-series lighting, Lithonia-series lighting, recessed, stage and custom design lighting and retrofit applications, and the like.

In FIG. 1C, an exemplary LED lighting system and method 100″ can receive power from the power source 122 (e.g., two-phase, 120 VAC, 240 VAC, etc.), and can include the phase correction circuit 120, the LED driver circuit 102, the printed circuit boards (PCBs) 104 or 104′ coupled to the LED driver circuit 102 via the wires 106, the one or more LEDs 108 (e.g., a Samsung LED package, including 9 individual LED dies in one package), the lens housing 100 or 110′ having the one or more lenses 112 or 112′, and the heatsink 114 or 114′, incorporated into an existing lighting housing 124 having an existing lighting lens 126. Advantageously, the exemplary LED lighting system and method of FIG. 1B can be used in retrofit applications for Hubbell-series lighting, Lithonia-series lighting, recessed and stage lighting, and the like.

In an exemplary embodiment, the LED lighting systems and methods of FIGS. 1A-1C can be configured so as to be rated as 12 V systems. For example, the LED driver circuit 102 can provide around 10 V up to around 12 V (or e.g., 10.9 V), direct current (DC) power to the PCBs 104 and 104′ via the wires 106. For example, the LEDs 108 can be configured to operate at around 180 milliamps at 12 V DC, as compared to conventional systems that operate at around 350 milliamps at 4 V DC. Advantageously, such a 12 V configuration allows for improved power factor correction, improved staging between the LEDs 108 and the AC power, improved AC to DC conversion, and the like, as compared to conventional systems and methods.

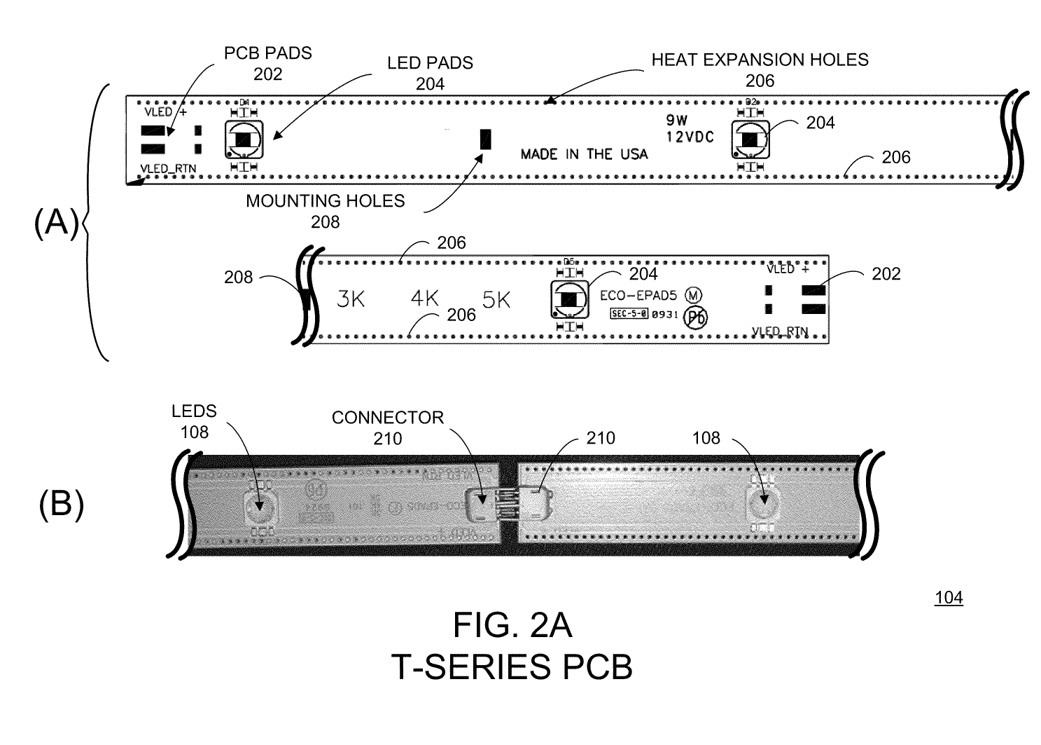

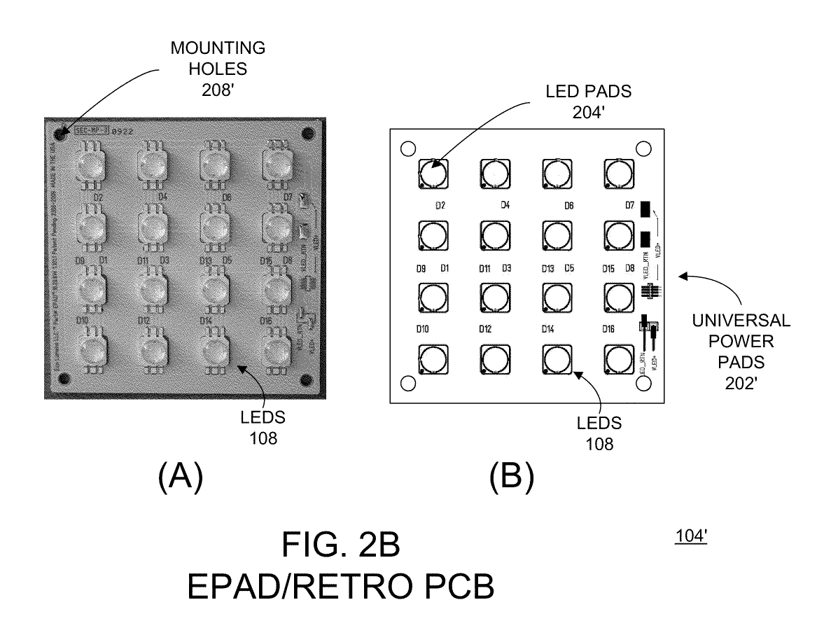

FIGS. 2A-2B illustrate exemplary printed circuit boards (PCBs) that can be used in the LED lighting systems and methods of FIGS. 1A-1C, according to exemplary embodiments. In FIG. 2A, the PCB 104 can accommodate one or more of the LEDs 108 via LED pads 204 (e.g., for a surface mount, solder connection). PCB pads 202 (e.g., for a solder connection) are provided for connecting the PCB 104 to the wires 106 and for connecting two or more of the PCBs 104 together in series via connectors 210. Heat expansion holes 206 as well as mounting holes 208 also are provided. In an exemplary embodiment, the PCB 104 can be configured with an exposed Gerber configuration on both sides of the PCB 104. Advantageously, the exposed Gerber configuration allows for a more reliable thermal contact between the PCB 104 and the heatsink 114 and the LEDs 108, allowing for faster thermal displacement between the LEDs 108 and the heatsink 114, and manufacturing cost savings. In further exemplary embodiments, however, conventional PCBs can be employed with an increase in manufacturing costs.

The LED lighting system and method of FIG. 1A includes numerous advantages over conventional lighting systems and methods, including retrofitting into any suitable fixture, providing reliable connections and allowing for mounting directly to ceilings or walls via the endcaps 116 and the tombstones 118, and providing linear, solid state (LED) retrofit lighting lamp replacement (e.g., for T5, T8 and T10 applications) with an average savings of about >40% in energy over fluorescent tube lighting (FTL) based lighting. In addition, the LED lighting system and method of FIG. 1A can be serviced or repaired in the field, includes plug and play installation using the endcap 116 and the tombstone 118 adapters, avoids bad connections and can mount directly to a ceiling or wall, avoids shadow stacking and a need for recycling, is light control capable (e.g., light zone, motion and light sensor compatible), is dimmable with a silicon-controlled rectifier (SCR) type wall dimmer, provides an ideal optical system with optical power correction lens conservation of radiance (e.g., electromagnetic radiation), increases footprint and LUX output, with 5 or 8 LEDs produces 250 lm @ 250 mA, has a high luminous efficiency, has a power factor of about 0.99 with THD of about <10%, can accept an input voltage of about 90V˜305 VAC, 50˜60 Hz, 300 mA-150 mA, and 480V and 600 VAC/24 VDC, has a CCT color temperatures of about of about 3000, 4000 and 5000 Kelvin, has a high color rendering index (CRI) of about 81, provides total lumens at a 4 ft high output at about 3040 lm @ 30 W, 1900 lm @ 18 W and at a 2 ft high output at about 1520 lm @ 14 W, 950 lm @ 9 W, operates in high humidity, has an instant start, is solar photovoltaic (PV) panel and wind turbine compatible, has beam angle base on fixture being retro, and has about a 50,000 hour lifespan on a solid state (LED) light source.

In FIG. 2B, the PCB 104′ can accommodate one or more of the LEDs 108 via LED pads 204′ (e.g., for a surface mount, solder connection). Universal power pads 202′ are provided for connecting the PCB 104′ to the wires 106 with various wiring configurations (e.g., for a solder connection, a Molex connection, a wiper blade connection, etc.). In an exemplary embodiment, the PCB 104′ can be configured as a metal core board, as compared to an exposed Gerber configuration. Advantageously, the metal core board configuration allows for proper heat dissipation between the PCB 104′ and the heatsink 114′ and the LEDs 108. In further exemplary embodiments, however, PCBs with an exposed Gerber configuration can be employed with accommodation for any increased heat dissipation.

The LED lighting system and method of FIGS. 1B-1C include numerous advantages over conventional lighting systems and methods, including providing an average energy savings of about >70% over incandescent, fluorescent or high intensity discharge (HID) lamps (e.g., mercury vapor, high pressure sodium, arc metal halide, pulse start metal halide, metal halide, etc.). In addition, the LED lighting system and method of FIGS. 1B-1C include the ability to be serviced or replaced in the field, high luminous efficiency, polarization-matched LEDs, CCT color temperatures of about 3000, 4000 and 5000 Kelvin, a high color rendering index (CRI) of about 81, a luminous flux for the LEDs of about 250 lm @ 250 mA Luminous Flux (1 W) (e.g., about 100 lm/W (@120 mA), electrical properties: Reverse Voltage VR IF=5 mA-−16.5 V Forward Voltage VF IF=250 mA S0 S1 8.9-10.0V), and a single sided MCPCB material (e.g., about 1 oz Copper/0.062 6061T6 ALUM ALLOY 1 MASK, WHITE, SILK GREEN, IMM AU, HI-POT TEST AT 1000 VDC FOR 3 SECOND).

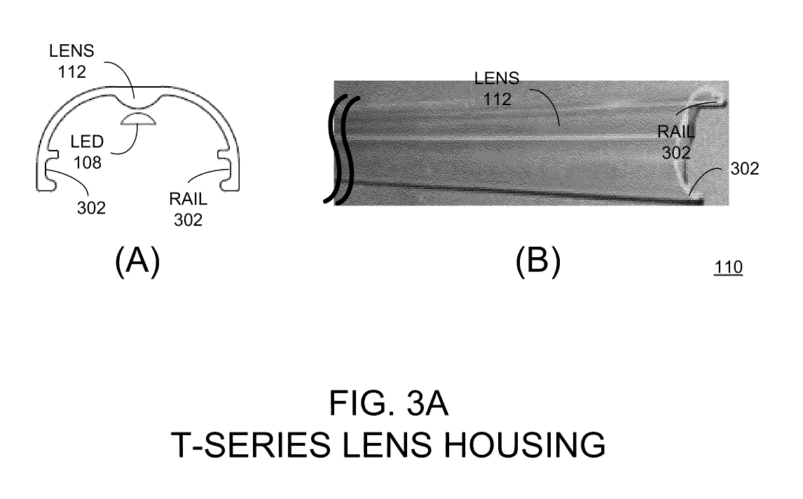

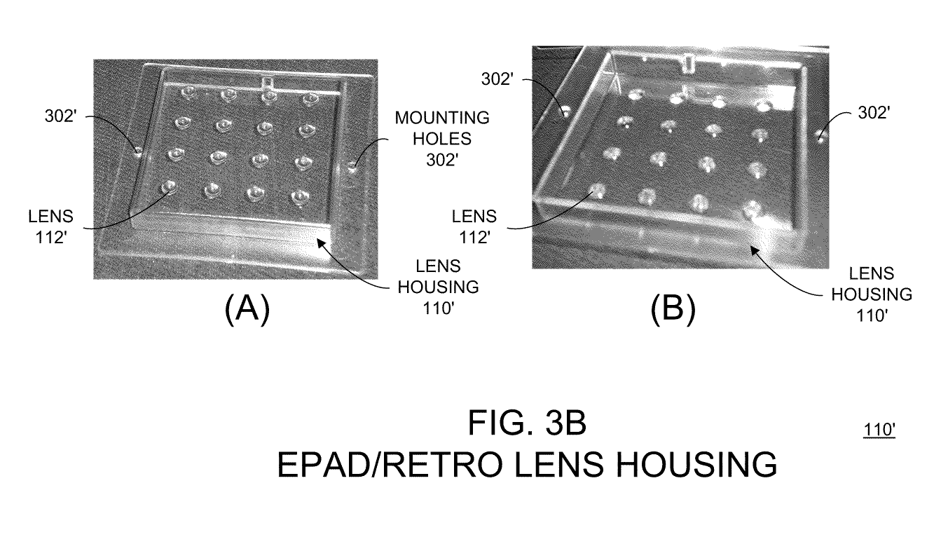

FIGS. 3A-3B illustrate exemplary LED lens housings that can be used in the LED lighting systems and methods of FIGS. 1A-1C, according to exemplary embodiments. In FIG. 3A, the LED lens housing 110 (e.g., made from a plastic material) can include the LED lens 112 integral with and disposed along the entire length of the LED lens housing 110 and configured to optically align with the LEDs 108 of the PCB 104. Rails 302 are provided for slidably mounting the LED lens housing 110 with the heatsink 114, advantageously, resulting in ease of assembly, disassembly, and maintenance.

In FIG. 3B, the LED lens housing 110′ (e.g., made from a plastic material) can include one or more of the LED lenses 112′ integral with and uniformly disposed throughout the LED lens housing 110′ and configured to optically align with the LEDs 108 of the PCB 104′. Mounting holes 302′ are provided for fixedly mounting the LED lens housing 110′ with the heatsink 114′, advantageously, resulting in ease of assembly, disassembly, and maintenance.

Advantageously, the lenses 112 and 112′ provide for light magnification and spreading functions, which can be modified based on the geometrical configurations of the lenses 112 and 112′. In addition, the lenses 112 and 112′ can be made of various colors (e.g., red, blue, green, yellow, etc.), provide an ideal optical system, provide optical power correction, provide conservation of radiance (e.g., electromagnetic radiation), and provide an increased emitted light footprint and LUX output, so as to accommodate a wide variety of lighting applications.

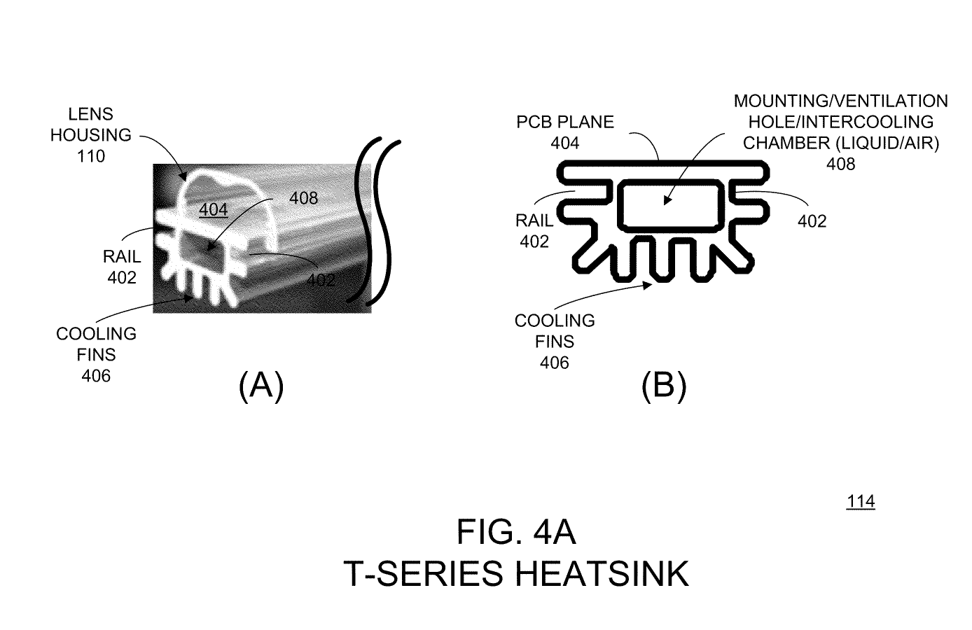

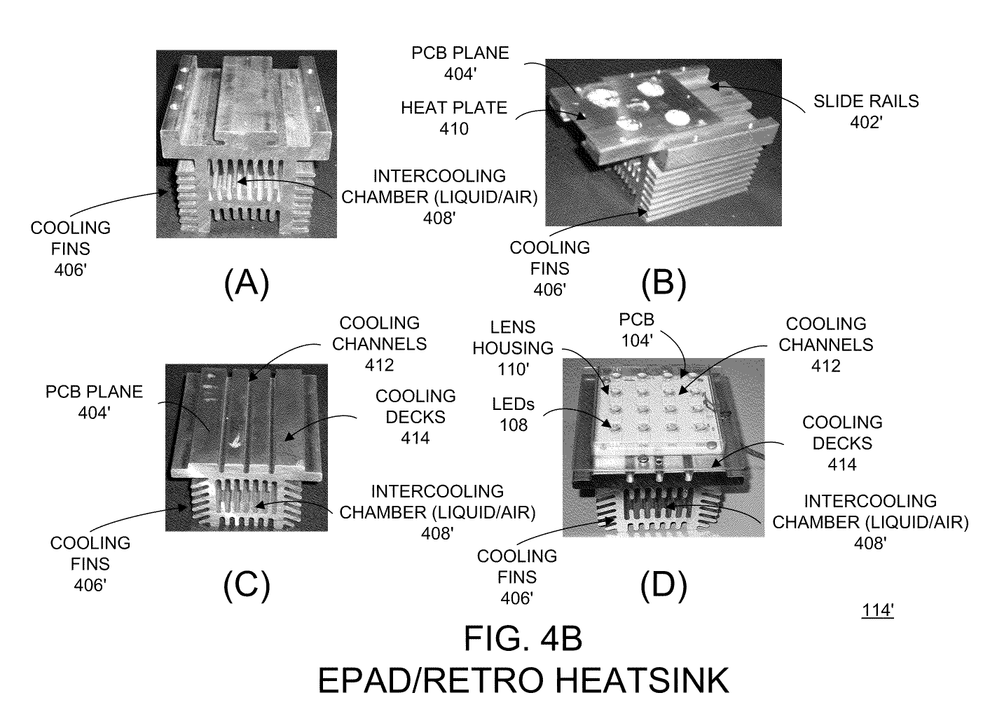

FIGS. 4A-4B illustrate exemplary heatsinks that can be used in the LED lighting systems and methods of FIGS. 1A-1C, according to exemplary embodiments. In FIG. 4A, the heatsink 114 (e.g., made of aluminum) can include rails 402 for slidably mounting with the LED lens housing 110, a PCB plane 404 for thermally coupling to and mounting of the PCB 104, and cooling fins 406 and mounting/ventilation hole/intercooling chamber 408 (e.g., configured for liquid and/or air cooling) for improved thermal dissipation.

In FIG. 4B, as shown in (A) and (B), a two-piece heatsink 114′ (e.g., made of aluminum) can include slide rails 402′ for slidably mounting with a heat plate 410, which attaches to the LED lens housing 110′, and includes a PCB plane 404′ for thermally coupling to and mounting of the PCB 104′, and cooling fins 406′ and ventilation hole/intercooling chamber 408′ (e.g., configured for liquid and/or air cooling) for improved thermal dissipation. As shown in (C) and (D), a one-piece heatsink 114′ further includes cooling channels 412 and cooling decks 414 that align with the rows of LEDs 108 on PCB 104′ for improved thermal dissipation and cooling.

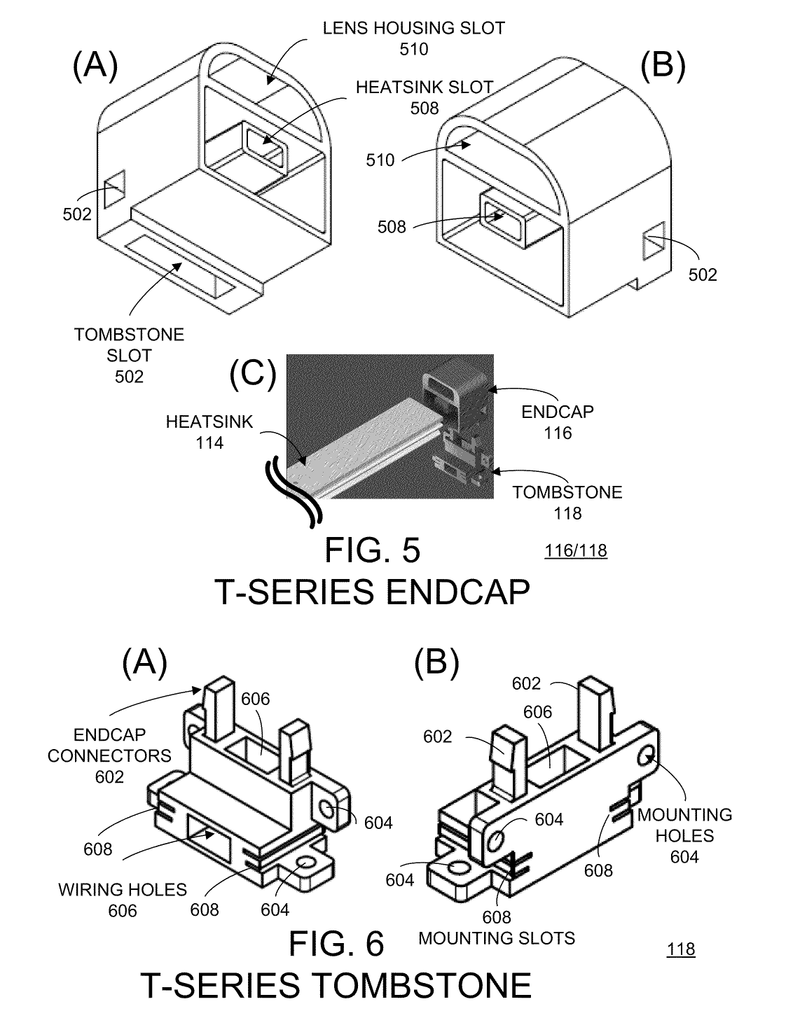

FIG. 5 illustrates an exemplary endcap that can be used in the LED lighting system and method of FIG. 1A, according to an exemplary embodiment. FIG. 6 illustrates an exemplary tombstone that can be used in the LED lighting system and method of FIG. 1A, according to an exemplary embodiment. In FIGS. 5-6, the tombstones 118 can be removably fixed onto a lighting housing fixture via the mounting hole 604. The endcaps 116 snap into place over the tombstones 118 via connectors 602 and corresponding mounting holes 502. The heatsink 114 slidably mounts into the endcaps 116 via mounting holes and slots 508. Similarly, the lens housing 110 slidably mounts into the endcaps 116 via the lens housing slots 510. A wiring pathway is provided via slots 606 on the tombstones 118 and the corresponding slots 510 of the endcaps 116. In this way, the wiring path from slot 510 continues through to the back wall of the endcap 116 and goes down 90 degrees and goes out the bottom through the slot 502 of the endcap 116 into the corresponding slot 606 of the tombstone 118. The tombstones 118 also can include linear mounting slots 608 for mounting onto conventional light fixtures. Advantageously, with the mounting holes 604 and the snap-in features of the endcaps 116 and the tombstones 118, various vertical or horizontal mounting options are provided.

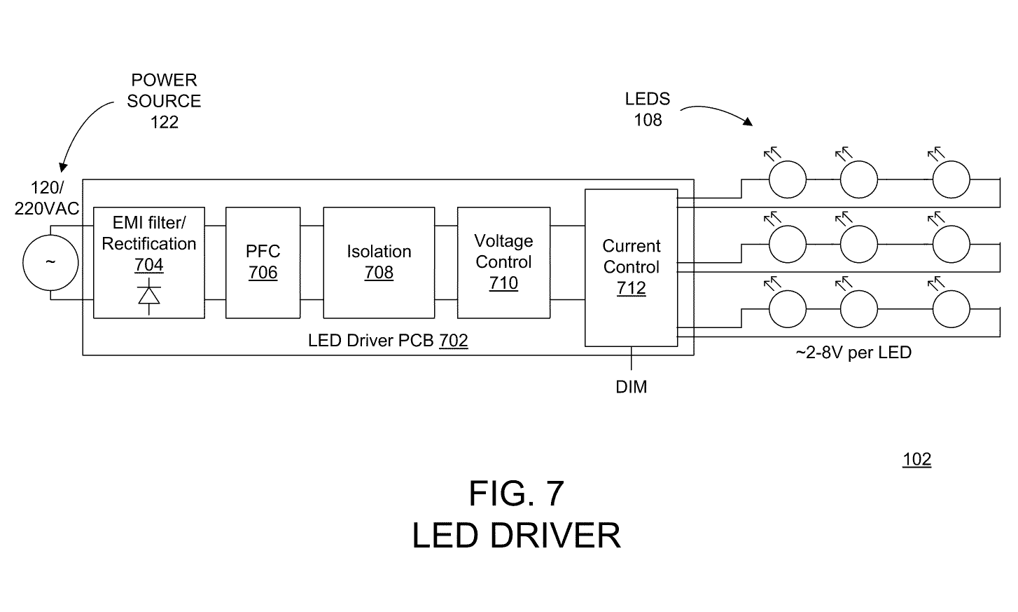

FIG. 7 illustrates an exemplary LED driver circuit that can be used in the LED lighting systems and methods of FIGS. 1A-1C, according to an exemplary embodiment. In FIG. 7, the LED driver circuit 102 receives power from the power source 122 and is mounted on a printed circuit board 702 and can include electromagnetic interference (EMI) filter/rectification circuit 704, power factor correction (PFC) circuit 706, current/voltage isolation circuit 708, voltage control circuit 710, and current control circuit 712. Although the LED driver circuit 102 of FIG. 7 is shown as driving three channels or banks of LEDs 108, advantageously, the LED driver circuit 102 can be configured from one to as many channels as are needed by appropriate scaling of the circuits 704-712. A dimming function (DIM) can be provided on the current control circuit 712, as shown in FIG. 7.

The LED driver circuit 102 includes numerous advantages over conventional LED driver circuits, including a wide input voltage range with high power factor (PF) and low total harmonic distortion (THD), efficiency that can be optimized with greater efficiency at higher power, dimming capabilities with various sources (e.g., phase cut, 0-10V, DALI, etc.), light control capabilities (e.g., light zone, motion and light sensor compatible, etc.), being dimmable with a typical silicon-controlled rectifier (SCR) type wall dimmer, providing multiple regulated outputs, capabilities for use in more expensive, high end applications with power above 50 W, an input voltage of about 90V˜305 VAC, 50˜60 Hz, 300 mA-150 mA, 480V and 600 VAC/24 VDC, ADVANCED PFC+BALLAST CONTROL IC, critical-conduction mode boost-type power factor correction (PFC), Power Factor Correction (PFC) with Power Factor of about 0.99 with total harmonic distortion (THD) of about <10%, compliance with IEC 60384-14, 3rd edition, isolation with step down, PFC over-current protection, half-bridge over-current protection, preheat frequency, preheat time, closed-loop ignition current regulation, closed-loop ignition regulation for reliable lamp ignition, ultra low THD, lamp removal/auto-restart function, front end circuit LED driver based on IR HVIC combo chip (e.g., PFC+High/Low side driver), current regulation with an LED Buck Regulator Control IC, output voltages of about 30 W @ 24 VDC, output operating frequency of about >=120 Hz, and synchronous rectification for increased efficiency in high output current applications (e.g., for 1.5 A LED panels with diode drop: 1.5 A×1V=1.5 W (+switching losses), synchronous rectification: 25 mOhm×1.5 A×1.5 A=0.06 W*Temperature difference on components >30 degrees C.).

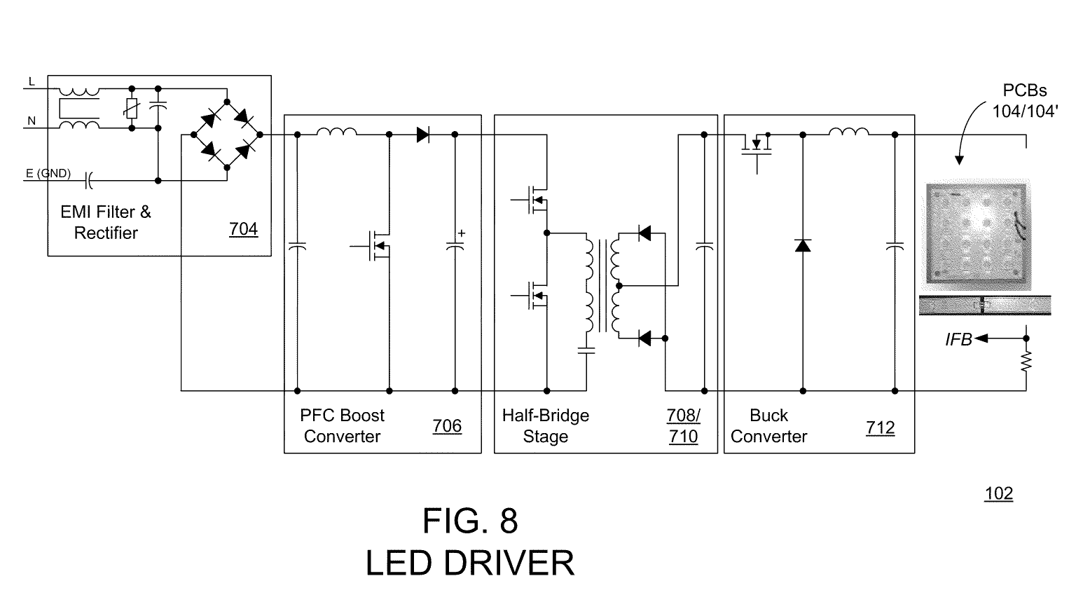

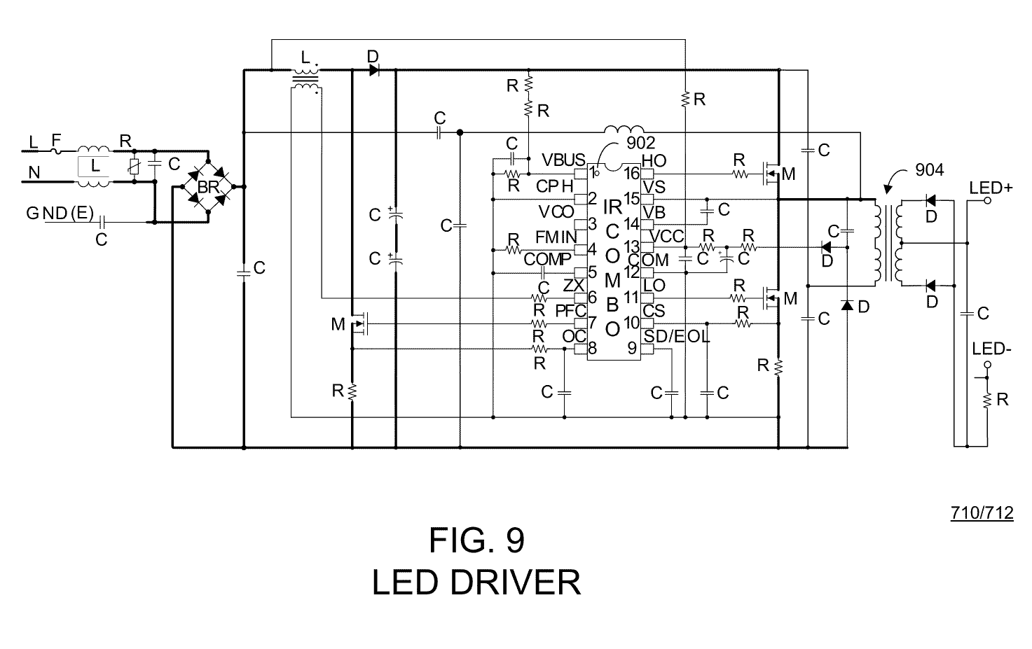

FIG. 8-9 illustrate exemplary sub-circuits of the LED driver circuit of FIG. 7, according to exemplary embodiments. In FIG. 8, the main stages inside the LED driver circuit 102 are shown, including a PFC boost converter stage 706 at the front end coupled to the EMI filter/rectification circuit 704, followed by a half bridge switcher and a step down transformer stage 708/710, and a final back end stage 712, including a constant current Buck regulator with inherent short circuit protection coupled to the PCBs 104 or 104′. In FIG. 9, circuits 710/712 of the LED driver circuit 102 are shown, including an infrared (IR) combo LED driver integrates circuit (IC) 902 with power factor correction and half bridge control. The IC 902 maintains a regulated high voltage bus and drives a primary of a step down transformer 904, while also providing a power factor above 0.9 at the AC input with low total harmonic distortion (THD).

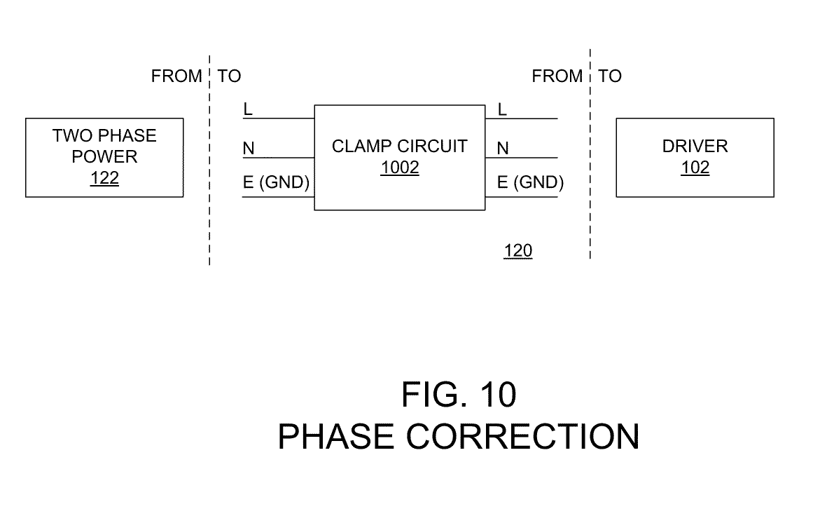

FIG. 10 illustrates an exemplary phase correction circuit of the LED lighting systems and methods of FIGS. 1A-1C, according to an exemplary embodiment. In FIG. 10, the phase correction circuit 120 is configured as a clamp circuit 1002 provided between the two phase power 122 and the LED driver circuit 102. Advantageously, the clamp circuit 1002 can be used to solve the problem of unbalanced neutrals when implementing A/B switching (e.g., for implementing Title 24 Energy Efficiency Standards). The clamp circuits 1002 can include one or more capacitors, zener diodes, and the like, configured to clamp any high voltage/current spikes due to unbalanced neutrals during A/B switching. The zener diodes can clamp down the high voltage/current spikes, with the capacitors being charged and then slowly discharged. The clamp circuit design of FIG. 10 is advantageous over designs using varistors and/or power cycle based designs.

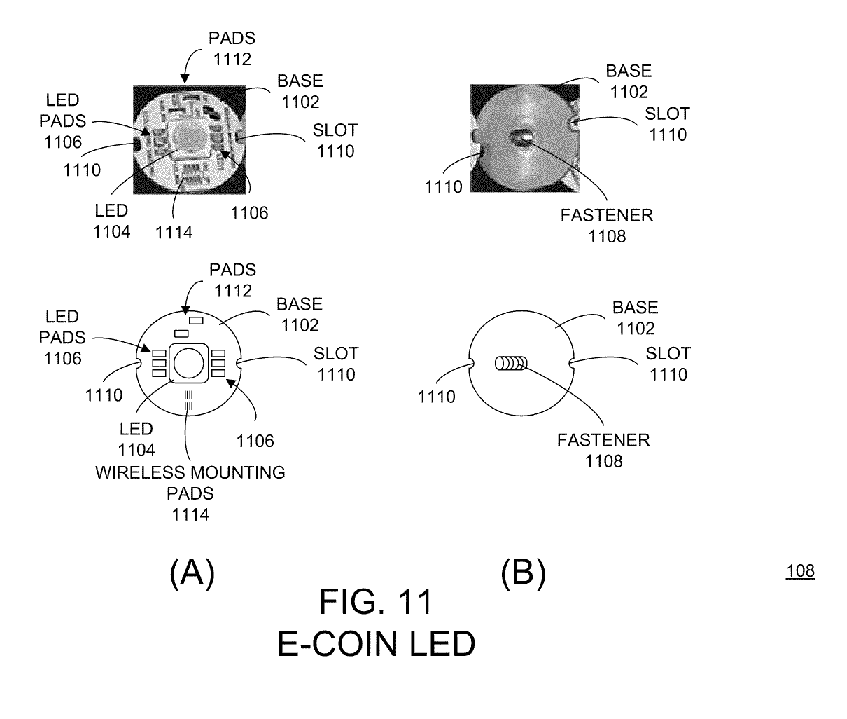

FIG. 11 illustrates an exemplary e-coin LED that can be used in the LED lighting systems and methods of FIGS. 1A-1C, according to an exemplary embodiment. In FIG. 11, an e-coin LED 108 can include a single LED package 1104 (e.g., a Samsung LED package, including 9 individual LED dies in one package) mounted on a metal disk heat sink/base 1102 having a fastener 1108 (e.g., a screw type faster) and mounting slots 1110 (e.g., for pneumatic assembly). The e-coin LED 108 further includes LED pads 1106 for mounting of the LEDs 1104 (e.g., for surface mount, solder mounting), two-wire wiring pads 1112 (e.g., for solder wiring), and wireless wiring pads 1114 (e.g., for solderless wiring using corresponding wiper blades, not shown). Advantageously, with this design, when the e-coin 108 is screwed down in place, the stud 1108 provides for ground continuity and the wipers blades from above (not shown) mate up with the wireless mounting pads 1114 to form an electrical connection.

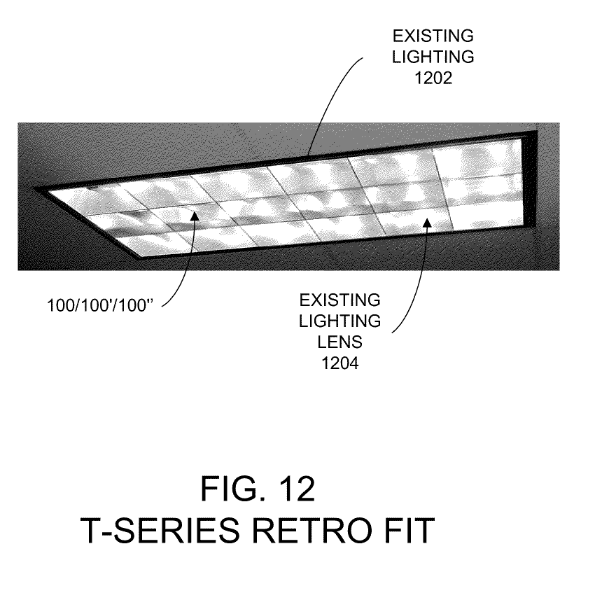

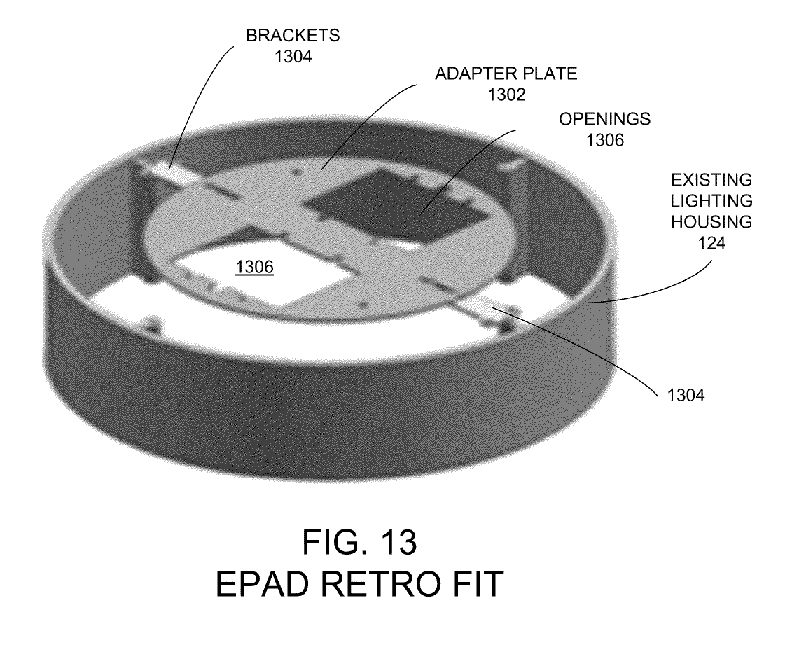

FIGS. 12-13 illustrate exemplary retrofit applications for the LED lighting systems and methods of FIGS. 1A-1C, according to exemplary embodiments. In FIG. 12, the LED lighting systems and methods 100-100″ of FIGS. 1A-1C can be incorporated into existing lighting 1202 and employ the existing lighting lenses 1204. In FIG. 13, the LED lighting systems 100′-100″ of FIGS. 1B-1C can be incorporated into the existing lighting housing 124 via brackets 1304 and an adapter plate 1302. Advantageously, one or more openings 1306 can be provided in the adapter plate 1302 to accommodate one or more of the PCBs 104 or 104′ of the lighting systems 100′-100″ of FIGS. 1B-1C.

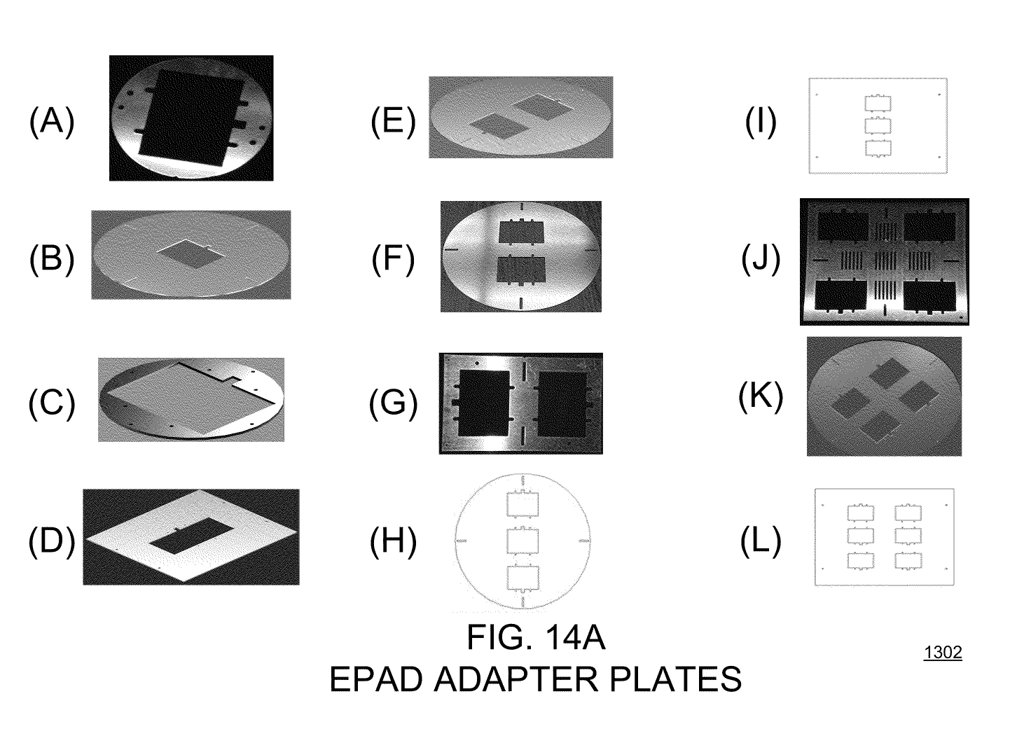

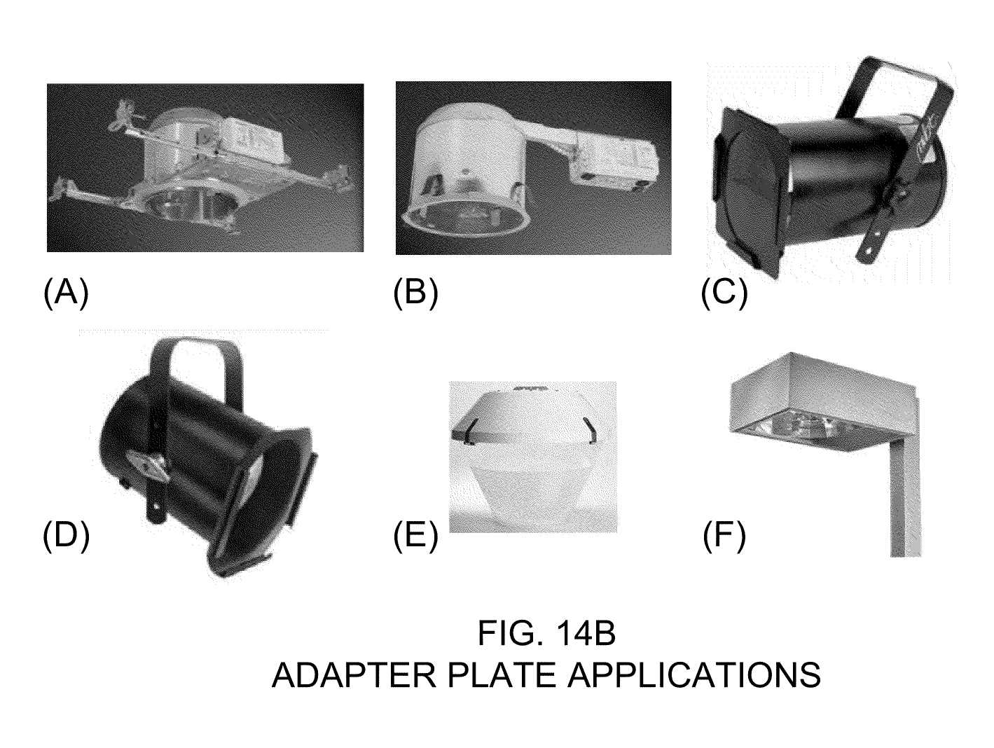

FIG. 14A illustrates exemplary adapter plates that can be used with the LED lighting systems and methods of FIGS. 1B-1C, according to exemplary embodiments. In FIG. 14A, advantageously, the adapter plates 1302 can be configured with any suitable combination of patterns, holes and slots, as shown in (A)-(L), for accommodating one or more of the PCBs 104 or 104′ of the lighting systems 100′-100″ of FIGS. 1B-1C.

FIG. 14B illustrates exemplary adapter plate applications for the adapter plates of FIG. 14A, according to exemplary embodiments. In FIG. 14 B, the adapter plates can be used in wall mount applications, ceiling mount applications, stage lighting applications, recessed lighting applications, Hubble lighting applications, Lithonia lighting applications, and the like, as shown in (A)-(F).

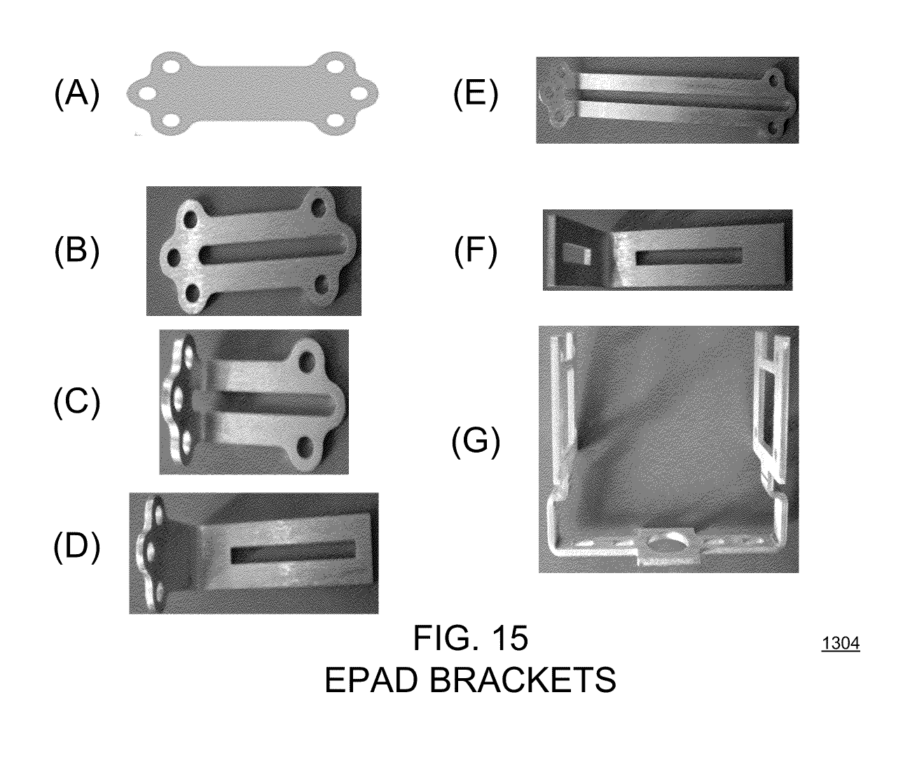

FIG. 15 illustrates exemplary brackets that can be used with the LED lighting systems and methods of FIGS. 1B-1C, according to exemplary embodiments. In FIG. 15, the brackets 1304 can be configured in a variety of configurations, as shown in (A)-(G), for accommodating the various applications described with respect to FIGS. 14A-14B.

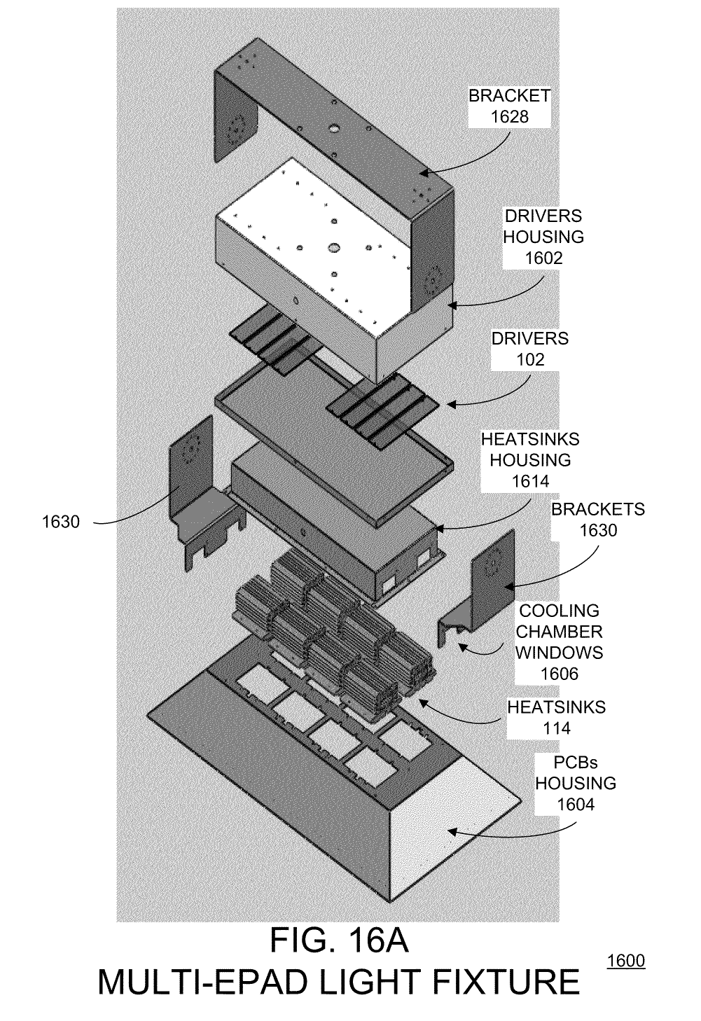

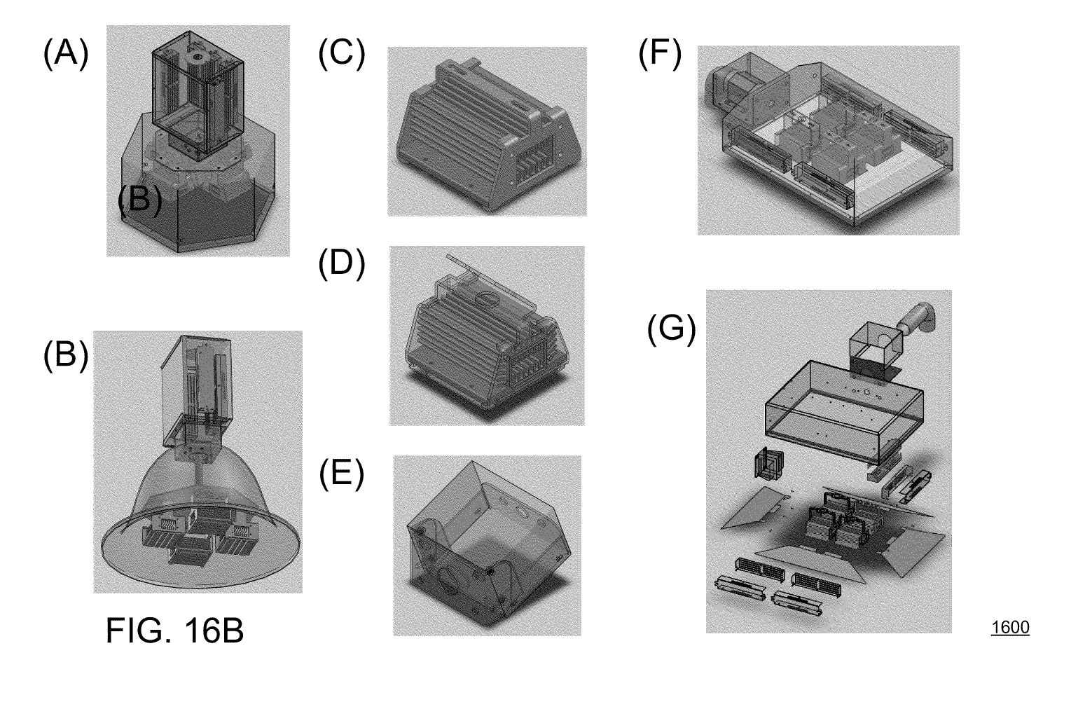

FIGS. 16A-16B illustrate exemplary light fixtures that can be used with the LED lighting system and method of FIG. 1B, according to exemplary embodiments. In FIG. 16A, a light fixture 1600 can include a housing 1602 for accommodating one or more of the LED drivers 102, a mounting bracket 1628, a housing 1614 for accommodating one or more of the heatsinks 114′ corresponding to the LED drivers 102, brackets 1630 including cooling chamber windows 1606 corresponding to the intercooling chambers 408′ of the heatsinks 114′, and a reflector housing 1604 for accommodating one or more of the PCBs 104′. In FIG. 16B, advantageously, the light fixture 1600 can be configured in a variety of configurations, as shown in (A)-(G).

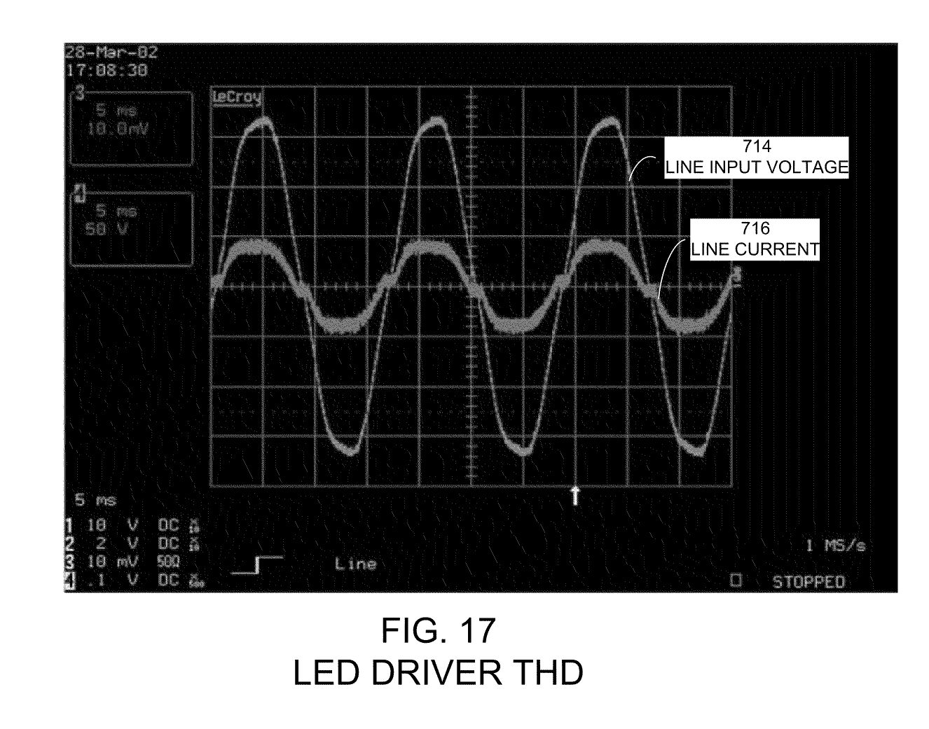

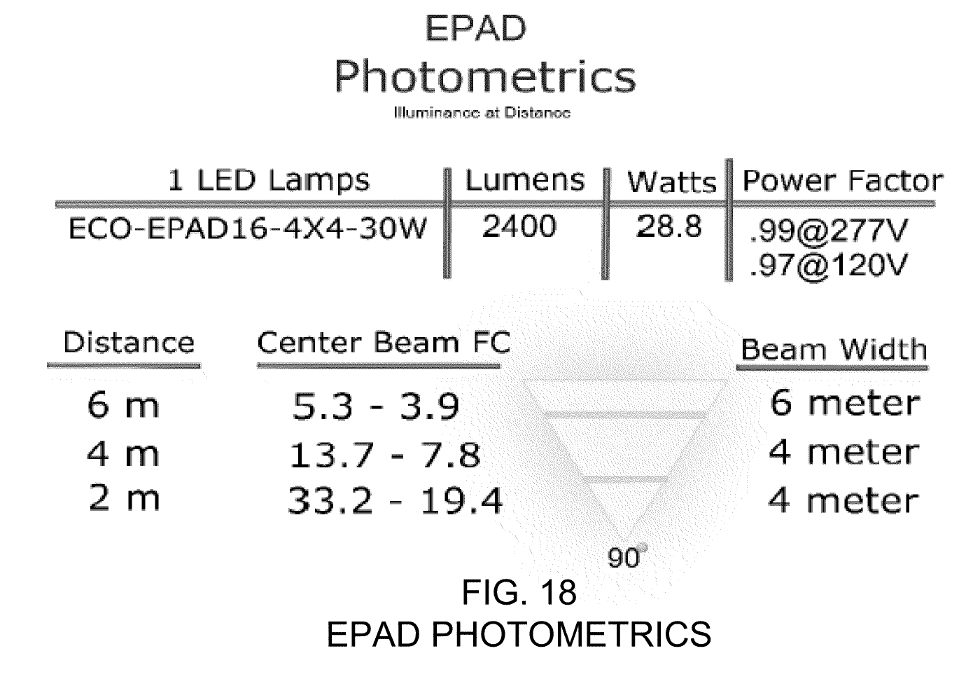

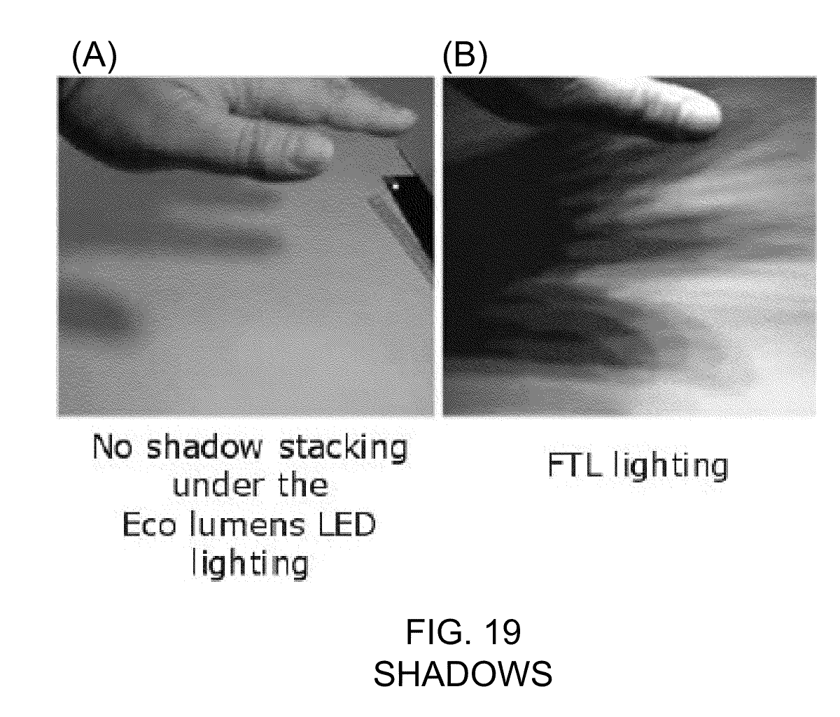

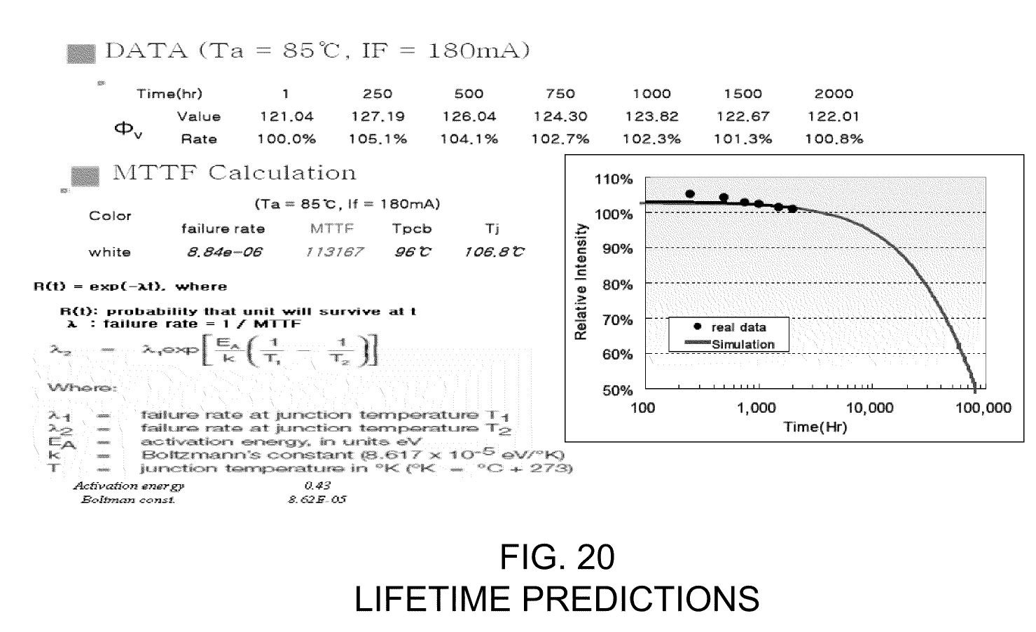

FIGS. 17-20 are exemplary graphs, charts and visuals for illustrating the electrical performance of the LED lighting systems and methods of FIGS. 1A-1C, according to exemplary embodiments. In FIG. 17, the performance of the LED driver circuit 102, including a full wave rectifier with power factor correction (PFC), is graphically shown, wherein the power factor is about 0.99 with a total harmonic distortion (THD) of less than about 10%, as can be measured from line input voltage trace 714 and line current trace 716. In FIG. 18, exemplary photometric measurements, including beam width measurements, are shown. In FIG. 19, as shown in (A), no shadow stacking occurs with the LED lighting systems and methods of FIGS. 1A-1C, as compared to conventional systems and methods (e.g., fluorescent tube lighting (FTL)), as shown in (B). In FIG. 20, exemplary lifetime predictions and corresponding measurements for the LED lighting systems and methods of FIGS. 1A-1C are shown.

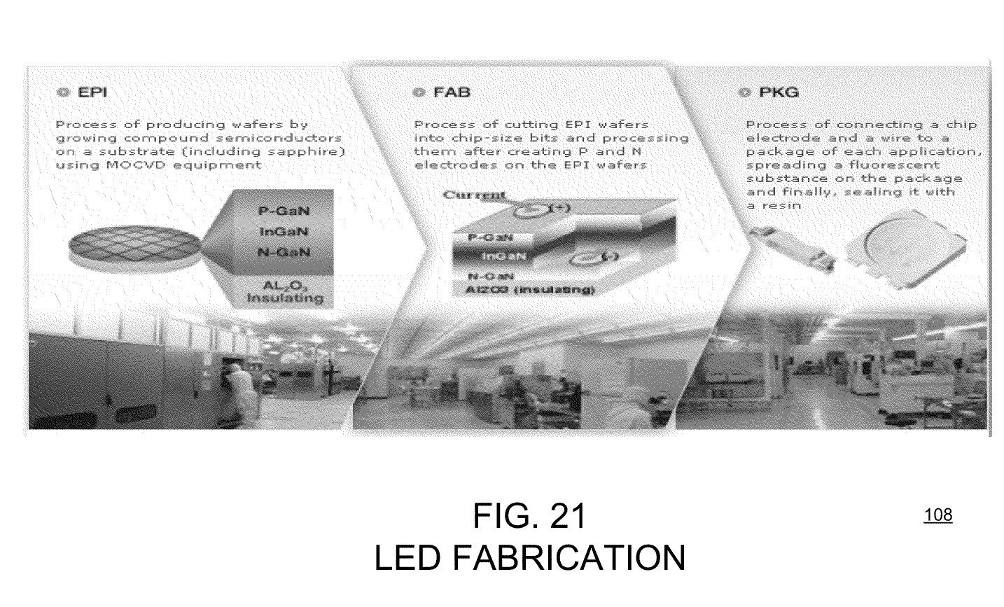

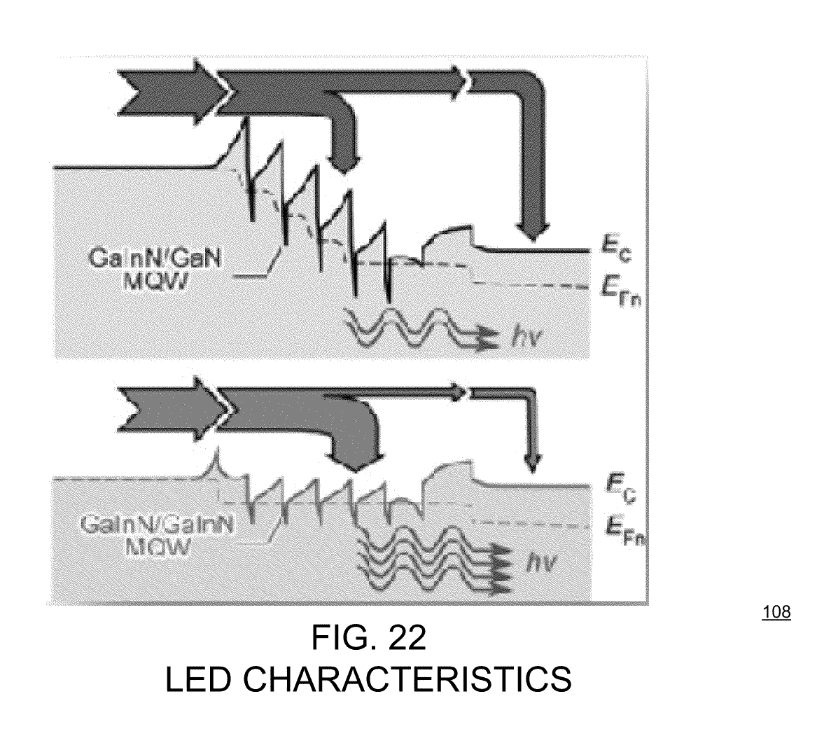

FIGS. 21-22 are exemplary graphs, charts and visuals for illustrating the electrical performance of LEDs that can be used in the LED lighting systems and methods of FIGS. 1A-1C, according to exemplary embodiments. In FIG. 21, an exemplary LED fabrication process for the LEDs 108 (e.g., a Samsung LED package, including 9 individual LED dies in one package) is shown. In FIG. 21, the LED characteristics of the LEDs 108 are shown, wherein the LEDs 108 are polarization-matched LEDs, exhibiting about an 18 percent increase in light output and about a 22 percent increase in wall-plug efficiency (e.g., which essentially measures the amount of electricity the LED converts into light), as compared to conventional LEDs.

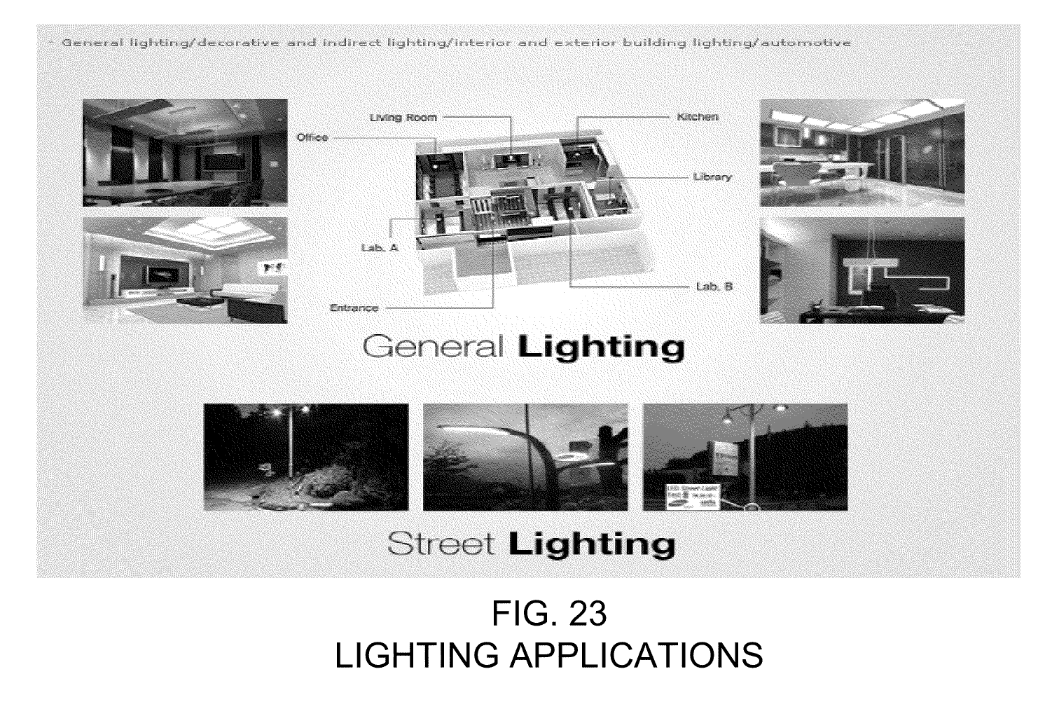

FIG. 23 illustrates exemplary lighting applications for the LED lighting systems and methods of FIGS. 1A-1C, according to exemplary embodiments. In FIG. 23, the LED lighting systems and methods of FIGS. 1A-1C can be used in a variety of applications, including general lighting, street lighting, and the like, applications. For example, the LED lighting systems and methods of FIGS. 1A-1C can be used in applications for office, inhabitancy, area tunnel, underground passage, railway, underground parking places, parks, advertising boards, roads, industrial buildings, warehousing, markets, courtyards, factories, city streets, pavements, squares, schools and yards, and the like.

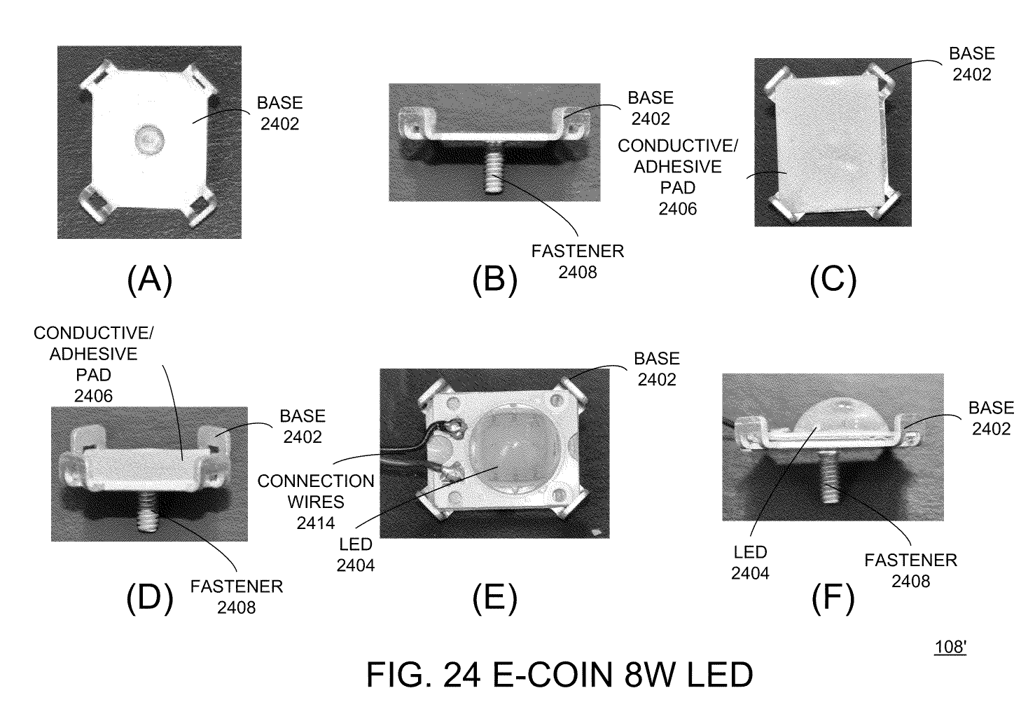

FIG. 24 illustrates an exemplary e-coin LED that can be used in the LED lighting systems and methods of FIGS. 1A-1C, according to an exemplary embodiment. In FIG. an e-coin LED 108′ can include a single LED package 2404 (e.g., a Samsung LED package, including a plurality individual LED dies in one package and operating at 8 W) mounted on a metal disk heat sink/base 2402 having a fastener 2408 (e.g., a screw type faster) and conductive/adhesive pad 2406. The e-coin LED 108′ further includes LED electrical wires 2414 (e.g., for solder wiring). Advantageously, with this design, when the e-coin 108′ is screwed down in place, the stud 1108 provides for ground continuity.

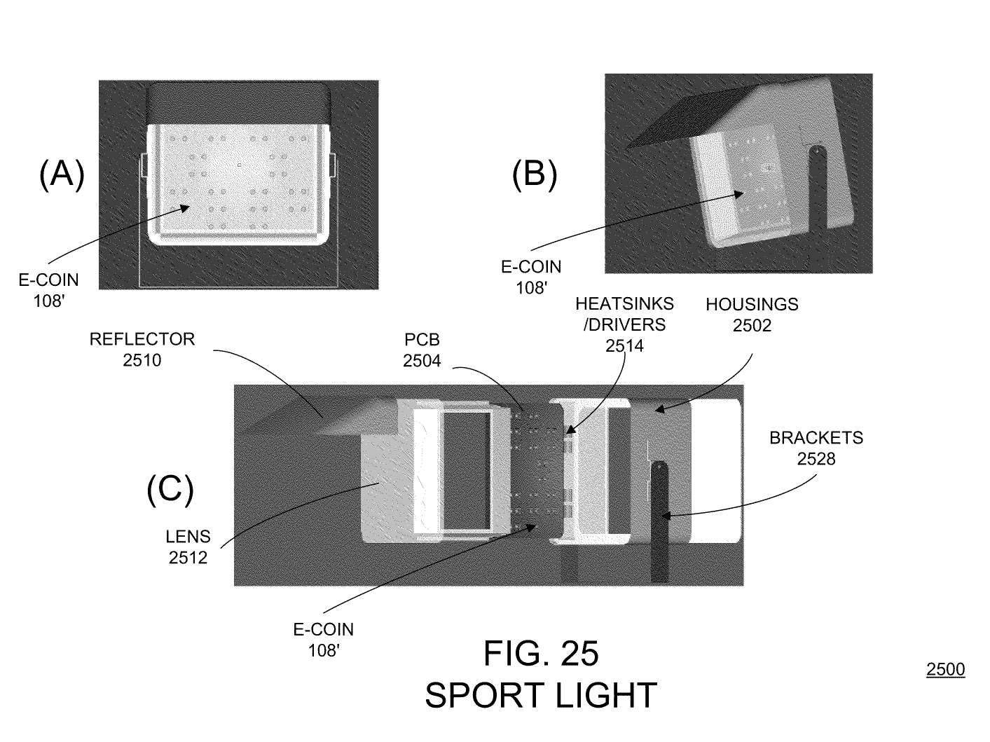

FIG. 25 illustrates an exemplary sport light fixture that can be used with the e-coin LED of FIG. 24, according to exemplary embodiments. In FIG. 25, a sport light fixture 2500 can include housings 2502 for accommodating one or more of the e-coin LEDs 108′ on PCB 2504, mounting brackets 2528, heatsinks/drivers 2514, reflector 2510, and lens 2512. Advantageously, the sport light fixture 2500 can be used in high output light applications, such as stadium application, flood light applications, and the like.

The LED lighting systems and methods of FIGS. 1A-1C include numerous advantages over conventional lighting systems and methods, including:

Energy Efficiency—LED lights burn very cool, while incandescent bulbs emit 98 percent of their energy as heat. Though currently more expensive to purchase up front, LED lighting saves in long-term operational costs and meets the new standards set forth by ASHRAE and others using a low wattage solid state system. LEED points are easily achievable when lighting a facility with an LED lighting system outdoors or indoors. Directionality and usable lumens make LED lighting systems and advantageous choice.

Long Life—LED lighting systems can last up to 100,000 hours. Incandescent light bulbs typically last around 1,000 hours and fluorescents are good for roughly 10,000 hours, wherein there is a substantial difference between the definitions of L70 Lifespan for LED lighting, and Average Lifetime of traditional lighting.

Rugged Durability—LED lights have no fragile filament to contend with, and no fragile tube. They are resistant to heat, cold, and shock. Solid state in nature, LED lighting is far more durable than any other type of lighting. No filaments, gases or thin glass ensures savings in breakage and shorter life due to ambient forces like wind, vibration, movement, and human error.

Shock Resistant—Unlike typical conventional light sources, LEDs are not subject to sudden failure or burnout as there are no filaments to burn out or break. In LEDs, the light emits from fully encapsulated silicon diodes immersed in phosphor, which can be energized from a very low voltage input.

Lumens per Watt (LPW)—While manufacturers are still finding new ways to increase this ratio, they have been able to produce in research an LED that generates 130 lumens/watt. Available LEDs are averaging from 50 to 90 lumens/watt, and incandescent bulbs are at about 15 lumens/watt.

LED Technology Reduces Carbon Emissions—Unlike incandescent, fluorescent or HID light bulbs, the LED lights are environmentally safe and ecologically friendly. There are no poisonous elements used in component manufacture, such as mercury or other noxious and polluting gases or substances (e.g., carbon dioxide, sulfur oxide). The LED lights reduce pollution and as such do not leach harmful poisons into the earth and atmosphere. The LED lights are re-usable, so they won't end up in a landfill, whereas special disposal costs must be taken into consideration with other types of lighting systems.

Compatibility—LED lighting is compatible with most systems. Some models screw in, replacing incandescent bulbs. Others can replace halogen bulbs, fluorescent tubes or high intensity discharge (HID) lamps.

Unparalleled Maintenance Savings—When determining lighting upgrade, the maintenance saving is a major factor in return on investment. Although important, many financial analysis overlook this factor altogether. Total system and total cost must be considered. The typical total life of 50,000 hours per unit with minimal degradation of light output with LED lighting eliminates the cost of periodic re-lamping and regular maintenance. LED units are also tamper/vandal proof.

Control Options—LED lighting systems can be used in conjunction with occupancy sensors and other lighting controls like dimmers, daylight controls and intelligent computer based programs. This has the potential to increase the life of a lighting system exponentially.

Eliminating Light Pollution—Light Pollution is virtually eliminated as light output from LEDs is directional, only directing light where it is required. This is highly efficient as no light is wasted when compared to conventional lighting where light is typically omni-directional from bulbs or tubes. Beams are available from 2°-135° for specific light guidance from light source. Directionality is an important feature of LED lighting, putting the light where needed.

Versatility—LED solid state lighting can be packaged in a variety of ways that were formerly impossible. Over the years, luminaries' manufacturers found innovative ways to take a generally dispersed light and direct it where they want it. SSL (Solid state lighting) makes it possible to entirely re-think both luminaries form factor, and installation methods.

No Need to Hold an Inventory of Different Types of Lamps—Once an LED lighting system is installed, there is not any need to store lamps. The LED lighting system offers lighting with interchangeable LED e-coins, epads, and drives, and with all other parts being reusable.

Installation Costs—As LED lighting becomes more widely used, many installation techniques can be changed where lighting is concerned. New development and building projects can save costs incurred with electrical construction of lighting systems. The low voltage operation of LED lighting allows for a multitude of low material cost design options.

Color Changing Ability—In applications where color is needed, LED lighting can be intelligently controlled, allowing virtually millions of color possibilities.

Lower Total Cost of Ownership (TCO)—LED lighting systems provide for cost effective, long term, outright cost of ownership with minimal initial system outlay when used as a replacement light supply using reduced voltage mains power (e.g., 110 Vac or 240 Vac converted to 12 Vdc or 24 Vdc). If the LED lighting is applied using photovoltaic solar power technology, then the savings are considerably greater.

Wider Range of Working Voltage Options—LED lighting only require tiny amounts of power to operate efficiently, which is ideal when considering systems to be run from photovoltaic solar or wind generated power (e.g., 24 Vdc or 48 Vdc). There is also the option of running LED lighting systems from mains generated power (e.g., 110 Vac˜277 Vac 50 Hz˜60 Hz) via transformers at vastly reduced running costs.

Low Heat Output—Maximum LED operating temperatures are typically 60° C. rather than the 300°-450° C. operating temperatures of conventional lighting solutions. Heat pollution is therefore reduced offering savings of secondary interior systems, such as air conditioning.

Quality Of Light—The quality of the “white” light available can be tailored with LED lighting to suit the human eye—eliminating eye strain, which in certain working and living environments can have adverse and costly implications, together with health and safety issues. LEDs do not produce ultraviolet light and can be perfectly matched to a specific color rendering index (CRI) for industrial and regulatory standards requirements.

It is to be understood that the devices and subsystems of the exemplary embodiments of FIGS. 1-25 are for exemplary purposes, as many variations of the exemplary hardware and/or devices used to implement the exemplary embodiments are possible, as will be appreciated by those skilled in the relevant art(s). In addition, the devices and subsystems of the exemplary embodiments of FIGS. 1-25 can be implemented by the preparation of application-specific integrated circuits or by interconnecting an appropriate network of conventional component circuits, as will be appreciated by those skilled in the electrical art(s). Thus, the exemplary embodiments are not limited to any specific combination of hardware circuitry and/or devices.

Although the devices and subsystems of the exemplary embodiments of FIGS. 1-25 are described with respect to exemplary configurations, the devices and subsystems of the exemplary embodiments of FIGS. 1-25 can be used together and/or separately in any suitable combinations, as will be appreciated by those skilled in the relevant art(s).

While the present invention have been described in connection with a number of exemplary embodiments and implementations, the present invention is not so limited, but rather covers various modifications and equivalent arrangements, which fall within the purview of the appended claims.

What is claimed is:

1. A light emitting diode (LED) lighting system, the system comprising at least one of:
a multi-channel LED driver circuit including an electromagnetic interference (EMI) filter and rectification circuit, a power factor correction (PFC) circuit, a current and voltage isolation circuit, a voltage control circuit, and a current control circuit;
a printed circuit board (PCB) including one or more surface mount or screw mount LEDs and electrically coupled to the LED driver circuit;
a heat sink including an intercooling and ventilation chamber for air or water cooling disposed therein and thermally coupled to the PCB; and
a lens housing having one or more lenses integrally formed therein and removably coupled to the heat sink with the lenses disposed over the LEDs.

2. The system of claim 1, further comprising:
a phase correction circuit coupled to an input of the LED driver circuit.

3. The system of claim 1, further comprising at least one of:
endcaps removably connected to ends of the heat sink and lens housing; and
tombstones removably connected to the endcaps.

4. The system of claim 1, wherein the PCB is square-shaped with a plurality of the LEDs uniformly dispersed on the PCB and optically aligned with a respective plurality of the lenses.

5. The system of claim 1, wherein the PCB is rectangular-shaped with a plurality of the LEDs uniformly dispersed, in series along a length of the PCB and optically aligned with a single respective lens disposed along a length of the lens housing.

6. A light emitting diode (LED) lighting method, including one or more process steps corresponding to the system of claims 1 through 5.

7. A light emitting diode (LED) lighting device, including one or more devices corresponding to the system of claims 1 through 5.
